(19) United States
(12) Patent Application Publication
(10) Pub. No.: US 2014/0210838 A1
(43) Pub. Date: Jul. 31, 2014

(54) VISUAL BUSINESS OBJECTS

(71) Applicants: Sameer Verma, Walldorf (DE); Armin Schwarz, Gaiberg (DE); Eduard Hess, Wiesloch (DE); Michael Rey, Speyer (DE); Jens Mett, Angelbachtal (DE); Heiko Steffen, Landau (DE); Sacha Droste, Wiesloch (DE); Peter Kuerpick, Darmstadt (DE)

(72) Inventors: Sameer Verma, Walldorf (DE); Armin Schwarz, Gaiberg (DE); Eduard Hess, Wiesloch (DE); Michael Rey, Speyer (DE); Jens Mett, Angelbachtal (DE); Heiko Steffen, Landau (DE); Sacha Droste, Wiesloch (DE); Peter Kuerpick, Darmstadt (DE)

(73) Assignee: SAP AG, Walldorf (DE)

(21) Appl. No.: 13/753,053

(22) Filed: Jan. 29, 2013

(51) Int. Cl. G06T 5/00

(52) U.S. Cl. CPC G06T 5/00
USPC 345/581

(57) ABSTRACT

A mapping between a business object and a corresponding visual representation of the business object may be read. The mapping may include a relationship between the business object's attributes and the visual representation's visual attributes. The mapping may include a relationship between the business object's attribute values and the visual representation's visual attribute values. The visual representation may be displayed on a graphical user interface based on the mapping.

### BACKGROUND

Business software such as enterprise resource planning (ERP) software implements business processes by modeling business data as business objects (BOs) with data exchange between the BOs. The business data provided via BOs can be accessed through mechanisms such as graphical user interfaces (GUIs), forms, and analytical reports.

Conventional business software typically displays BO data in a text, numeric, or chart format. While such an interface can present large amounts of data to a user, there are many drawbacks to this approach. By viewing BO data in a text, numeric, or chart format, for analytical purposes, it is difficult to identify specific BO data with particular attributes. Although a search may be performed on the BO data to narrow the results, such a search may require additional steps and may be time consuming, especially if the search has to be performed multiple times. In addition, BO data presented in a numeric table format is typically not interesting to a user.

### BRIEF DESCRIPTION OF THE DRAWINGS

FIG. 1 illustrates a GUI to display visual representations of BOs according to an embodiment.

FIG. 2 illustrates a GUI to display visual representations of BOs according to an embodiment.

FIG. 3 illustrates mappings between BOs and visual representations of BOs according to an embodiment.

FIG. 4 shows an exemplary architecture in an embodiment of the invention.

FIG. 5 shows an exemplary architecture in an embodiment of the invention.

### DETAILED DESCRIPTION

Embodiments may be discussed in systems to visually display information about BOs. In an embodiment, a mapping between a business object and a corresponding visual representation of the business object may be read. The mapping may include a relationship between the business object's attributes and the visual representation's visual attributes. The mapping may include a relationship between the business object's attribute values and the visual representation's visual attribute values. The visual representation may be displayed on a graphical user interface based on the mapping.

In an embodiment, the visual representation may be displayed relative to a visual context displayed on the graphical user interface. In an embodiment, in response to an activation of the visual representation, a magnified view of the visual representation may be displayed. In an embodiment, in response to a user action performed on the magnified view of the visual representation, information associated with the business object may be modified. In an embodiment, in response to a user action performed on the magnified view of the visual representation, an electronic communication with a person associated with the business object may be initiated. In an embodiment, in response to the activation, additional visual attributes of the visual representation may be displayed. In an embodiment, in response to a user action performed on the visual representation, information associated with the business object may be modified. In an embodiment, in response to a user action performed on the visual representation, an electronic communication with a person associated with the business object may be initiated.

Business software usually includes a standard set of BOs which can be utilized by the software user to model a business entity. For example, business software may include BOs representing business entities such as contacts, sales opportunities, trade promotions, sales orders, sales quotes, customer quotes, service documents, etc. Each BO may include attributes which define metadata associated with the BO. For example, a business promotion BO may represent a business promotion offered by a first company through a second company to consumers. The first company may be a soft drink company and the second company may be a major retailer. The promotion may have a start date and an end date (a promotion period). The promotion may offer the product, for example, a soft drink, for the promotion period at a particular sale price. The business promotion BO may include attributes such as the name of the second company, the size of the second company, the type of the second company, the name of the promotion product, the sale price of the product during the promotion, the price of the product without the promotion, the quantity of the product sold during the promotion, the start date of the promotion, and the end date of the promotion.

In an embodiment, the attributes of a BO may include other associated BOs. For example, a company BO may represent a customer company. The customer company may include employees who serve as communication contacts. To reflect this relationship, the company BO may include contact BOs representing the communication contacts.

Conventional business software typically displays BO data in a text, numeric, or chart format. While such an interface can present large amounts of data to a user there are many drawbacks to this approach. By viewing BO data in a text, numeric, or chart format, for analytical purposes, it is difficult to identify specific BO data with particular attributes. Although a search may be performed on the BO data to narrow the results, such a search may require additional steps and may be time consuming, especially if the search has to be performed multiple times. In addition, BO data presented in a numeric table format is typically not interesting to a user. A user utilizing the BO data may be more motivated to analyze the BO data if the data is presented in a more “attention-grabbing” manner. For example, videogame enthusiasts may be more motivated to analyze BO data if the data is presented in a more interactive fashion.

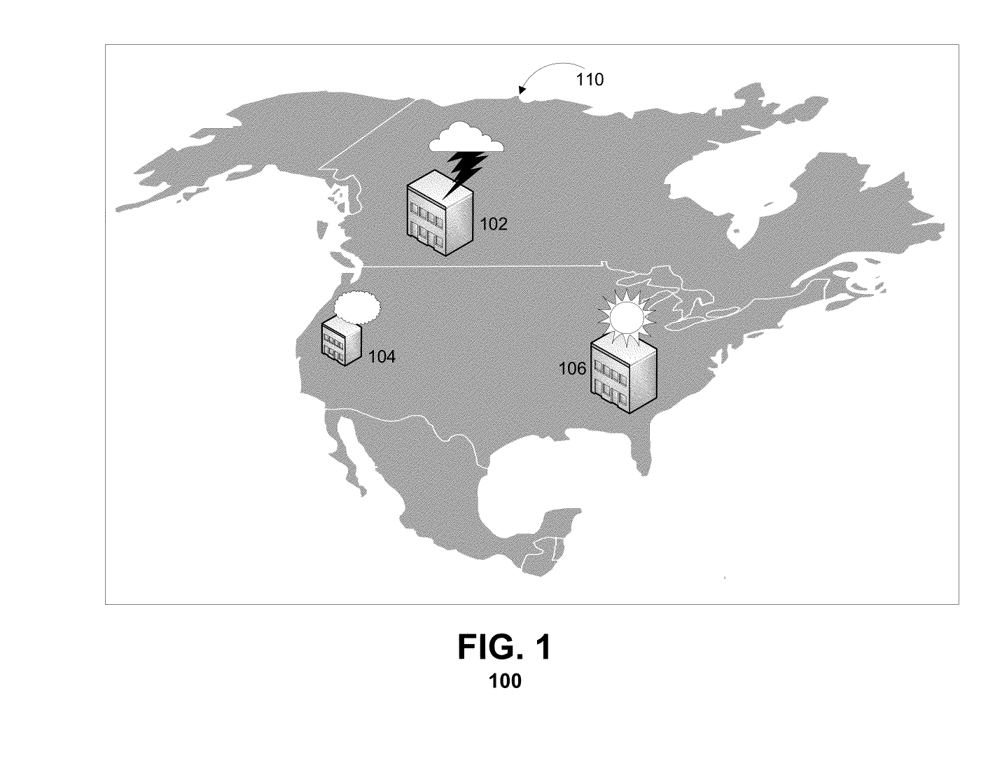

To address the above issues, in an embodiment, BO data may be presented in a visual format. FIG. 1 illustrates a GUI 100 to display visual representations of BOs according to an embodiment. For example, BO visual representations 102, 104, and 106 may be associated with three respective underlying BOs. The underlying BOs may be customer BOs and therefore, the BO visual representations 102, 104, and 106 may resemble office buildings. In an embodiment, the visual attributes of the BO visual representations may convey information associated with the underlying BOs. For example, the visual size of each customer BO representation 102, 104, and 106 may reflect the total assets of the respective underlying customer BO. Therefore, if the underlying customer BO of visual representation 102 has fewer assets than the underlying customer BOs of visual representations 104 and 106, visual representation 102 may be displayed smaller than visual representations 104 and 106.

In another example, visual attributes of the customer visual representations 102, 104, and 106 may indicate the customer satisfaction associated with the underlying customer BOs. The customer associated with visual representation 102 may be unhappy, the customer associated with visual representation 104 may be satisfied, and the customer associated with visual representation 106 may be very happy. Therefore, a lightning visual attribute may be displayed with visual representation 102 to indicate that the associated customer is unhappy, a cloud visual attribute may be displayed with visual representation 104 to indicate that the associated customer is satisfied, and a sunshine visual attribute may be displayed with visual representation 102 to indicate that the associated customer is very happy.

In an embodiment, the GUI 100 may display one or more visual contexts and the BO visual representations may be displayed relative to the one or more visual contexts to convey additional information about the underlying BOs. A visual context may be any visual element which displays possible values of one or more business attributes. For example, a visual context may be a geographical map, a scale, a chart, etc. In an exemplary embodiment, a geographical map 110 may be displayed on GUI 100 as a visual context. The underlying customer BOs of visual representations 102, 104, and 106 may be associated with a geographical location. Specifically, the geographical location associated with the customer BO may be the location of the customer's headquarters. Each visual representation 102, 104, and 106 may be displayed at a position relative to the geographical map 110 to indicate the approximate geographical location of the customer.

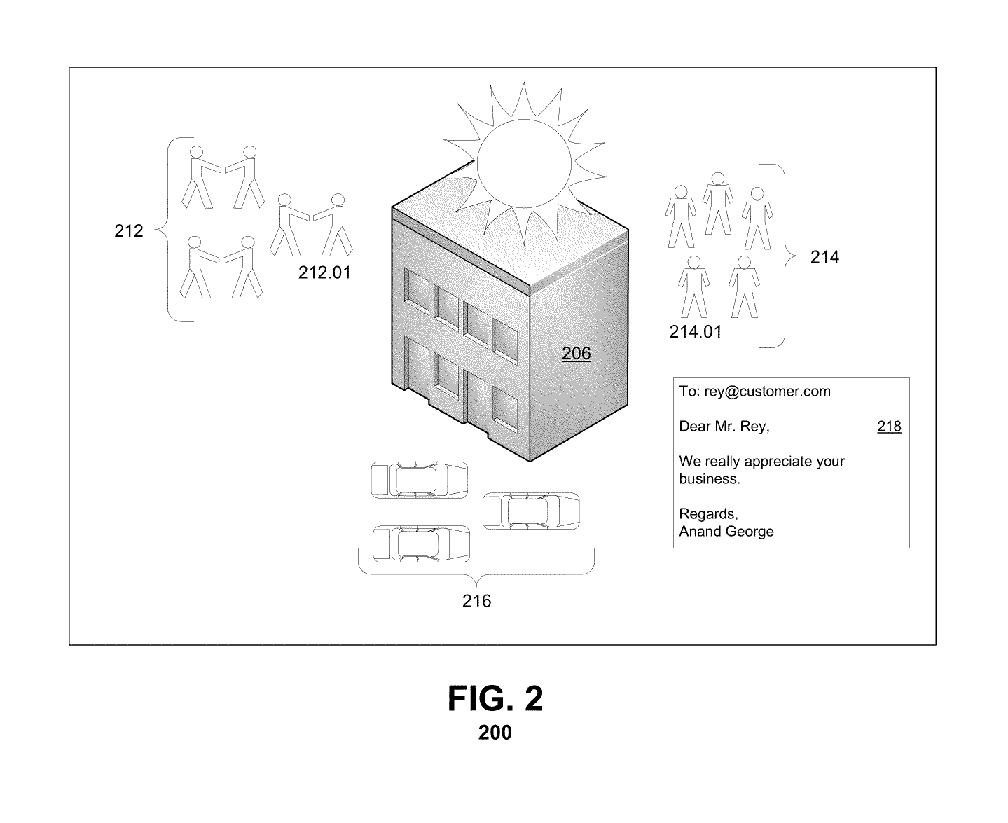

In an embodiment, a BO visual representation may be activated to display additional details associated with the BO visual representation. In an embodiment, activating a BO visual representation may trigger a “zooming in” and a magnified view of the activated BO visual representation may be presented on the GUI. FIG. 2 illustrates a GUI 200 to display a magnified view of a BO visual representation according to an embodiment. Activating a BO visual representation such as visual representation 106 may present a magnified view of the visual representation. Visual representation 206 may be magnified version of the customer BO visual representation 106. In an embodiment, the magnified view may present additional visual attributes 212, 214, and 216 associated with visual representation 206. The visual attributes 212, 214, and 216 may convey additional information associated with the underlying BO of visual representation 206. For example, visual attributes 212 may indicate the current business opportunities available at the customer company represented by visual representation 206. Each visual attribute 212 (displayed as an exemplary icon showing two people shaking hands) may represent a business opportunity. Visual attributes 214 may indicate the contact persons at the customer company. Visual attributes 216 may indicate the sales orders placed by the customer company.

In an embodiment, actions may be performed on visual representations, magnified views of the visual representations, visual attributes, and/or visual contexts. In response to the actions, information associated with the corresponding BOs may be altered. For example, an action may be performed by a user such as a sales manager to reflect a successful business opportunity which resulted in a sales order. The action may be visually dragging the corresponding business opportunity attribute 212.01 from the set of business opportunity attributes 212 to the set of sales order attributes 216. Responsive to the action, the business opportunity attribute 212.01 may be visually converted into a sales order attribute. The underlying customer BO of visual representation 206 may be automatically modified to reflect the conversion. In an embodiment, the changes to the underlying BOs may be persisted in a storage device such as a database.

In an embodiment, a communication may be initiated and/or transmitted in response to actions performed on visual representations, magnified views of the visual representations, visual attributes, and/or visual contexts. For example, a user may want to send an e-mail to a business contact at the customer company represented by visual representation 206. Therefore, the user may right-click on the corresponding contact visual attribute 214.01 and select an option to “send e-mail” from a right-click menu. Responsive to the action, the user may be presented with an e-mail composition window 218 prefilled with the e-mail address of the business contact corresponding to visual attribute 214.01. The user may then send the e-mail 218 to the business contact. Although e-mail is discussed as a form of communication for illustration purposes, in other embodiments, any form of communication may be initiated and/or transmitted including text message (such as text messages sent using a Short Message Service (SMS) and/or Multimedia Messaging Service (MMS)), multimedia chat, video chat, telephone call, audio conference, video conference, and application specific communication such as a Skype®, Google® chat, and WhatsApp® message.

A person having ordinary skill in the art will appreciate that activation of visual representations of BOs and actions performed on visual representations may be implemented in many ways including implementation through a mouse, keyboard, trackball, joystick, motion sensor, sensor on a touch screen of a device displaying the GUI, etc. In an embodiment, activation of displayed elements may be implemented through output from a motion sensor. For example, shaking and/or tilting a PC tablet with a motion sensor in a particular manner may activate the displayed elements.

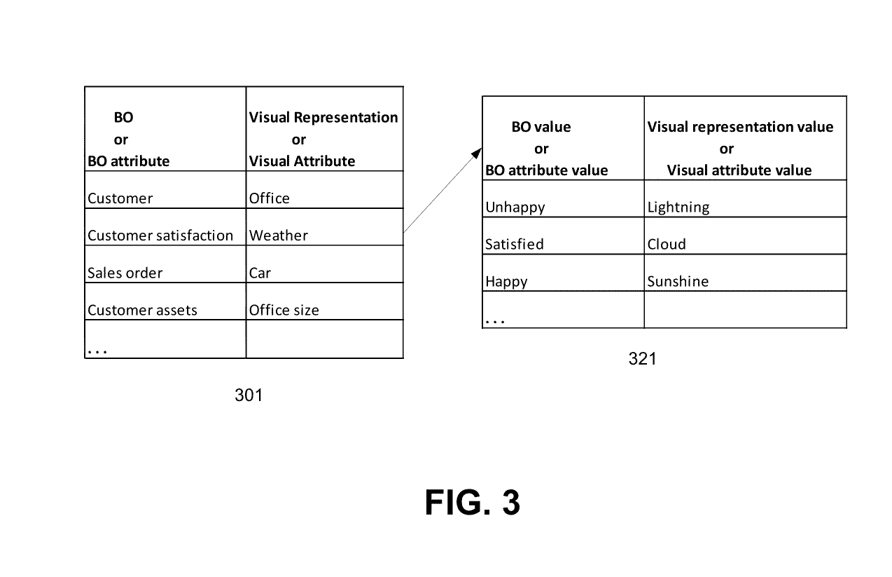

FIG. 3 illustrates mappings between BOs and visual representations of BOs according to an embodiment. In an embodiment, the presentation of BO visual representations and/or visual attributes on a GUI (such as GUI 100 or 200) may be based on one or more mappings between BO visual representations (and/or BO visual attributes) and the corresponding BOs (and/or BO attributes). The mappings may be stored on a storage device such as a database. For example, mapping 301 may define the relationship between the BO visual representations/attributes shown in FIG. 1 and FIG. 2 and their underlying BOs/BO attributes. Therefore, the customer BO may be mapped to an “office” visual representation. Specifically, each customer BO may be displayed on GUI 100 and 200 as an image of an office. Similarly, the customer satisfaction BO/BO attribute may be mapped to a “weather” visual representation. The sales order BO/BO attribute may be mapped to a “car” visual representation. The customer assets BO/BO attribute may be mapped to an “office size” visual attribute. Specifically, the size of each office image (i.e., customer) displayed on the GUI may be proportional to the size of each corresponding customer's assets.

Multiple mappings may define multiple levels of relationships between the BO visual representations/attributes. For example, mapping 321 may define the relationship between the BO visual representations/attributes' values shown in FIG. 1 and FIG. 2 and their underlying BOs/BO attributes' values. As explained above, mapping 301 maps the customer satisfaction BO/BO attribute to a weather visual representation, but mapping 301 does not include which customer satisfaction value corresponds to each weather value. This information may be included in mapping 321. Specifically, as seen in mapping 321, an “unhappy” customer satisfaction value may be mapped to a “lightning” image. A “satisfied” customer satisfaction value may be mapped to a “cloud” image. A “happy” customer satisfaction value may be mapped to a “sunshine” image.

A person having ordinary skill in the art will appreciate that the mappings shown in FIG. 3 are illustrative and are not intended to limit the scope of the invention. The mappings may be organized in any manner. For example, the information in mapping 301 and mapping 321 may be combined into a single mapping table. That is, the mappings may normalized or denormalized as necessary. The mappings may include other information such as the remote and/or local paths of particular multimedia files to be displayed on the GUI and other information necessary to display the visual representations and/or visual attributes.

A person having ordinary skill in the art will appreciate that although the discussion above refers to visual representations and visual attributes of BOs, the principles described also apply to audio-visual representations and/or audio-visual attributes of BOs. Visual representations/attributes/contexts may include still images, moving images, and/or videos.

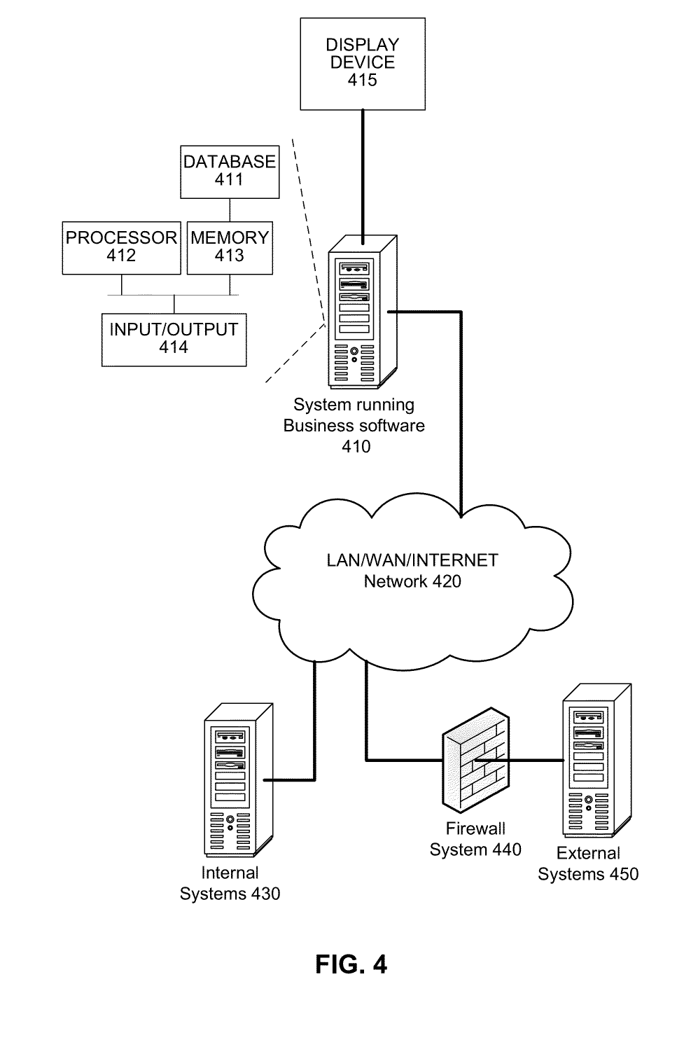

FIG. 4 shows an exemplary architecture in an embodiment of the invention. The system running an application to view, create, or modify BOs 410 may be coupled to a display device 415, existing internal systems 430 through a network 420 and to external systems 450 through the network 420 and firewall system 440. The system running an application to view, create, or modify BOs 410 may include a desktop computer, laptop computer, tablet PC, client computer, mobile phone, central computer in a vehicle, any device with a touch screen, and any other computer. The display device 415 may include a computer monitor, a touch screen, a tablet PC screen, a mobile phone screen, and any other displays. The existing internal systems 430 may include a server and may provide business data and/or other data. The external systems 450 may include a server and may be maintained by a third party, such as an information service provider, and may contain business data and/or other data, that may be updated by the third party on a periodic basis. The system running an application to view, create, or modify BOs 410 may interact with these external systems to obtain updates through a firewall system 440 separating the internal systems from the external systems.

A person having ordinary skill in the art will appreciate that while internal systems 430 and external systems 450 are included in FIG. 4, in some embodiments, one or both of these systems may not be required. In an embodiment, the functionality provided by the internal systems 430 and external systems 450 may be provided by the system running the application to view, create, or modify BOs 410.

Each of the systems in FIG. 4 may contain a processing device 412, memory 413, a database 411, and an input/output interface 414, all of which may be interconnected via a system bus. In various embodiments, each of the systems 410, 430, 440, and 450 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 413 may contain different components for retrieving, presenting, changing, and saving data. Memory 413 may include a variety of memory devices, for example, Dynamic Random Access Memory (DRAM), Static RAM (SRAM), flash memory, cache memory, and other memory devices. Additionally, for example, memory 413 and processing device(s) 412 may be distributed across several different computers that collectively comprise a system.

Database 411 may include any type of data storage adapted to searching and retrieval. The database 411 may include SAP database (SAP DB), Informix, Oracle, DB2, Sybase, and other such database systems. The database 411 may include SAP's HANA (high performance analytic appliance) in-memory computing engine and other such in-memory databases.

Processing device 412 may perform computation and control functions of a system and comprises a suitable central processing unit (CPU). Processing device 412 may comprise a single integrated circuit, such as a microprocessing device, or may comprise any suitable number of integrated circuit devices and/or circuit boards working in cooperation to accomplish the functions of a processing device. Processing device 412 may execute computer programs, such as object-oriented computer programs, within memory 413.

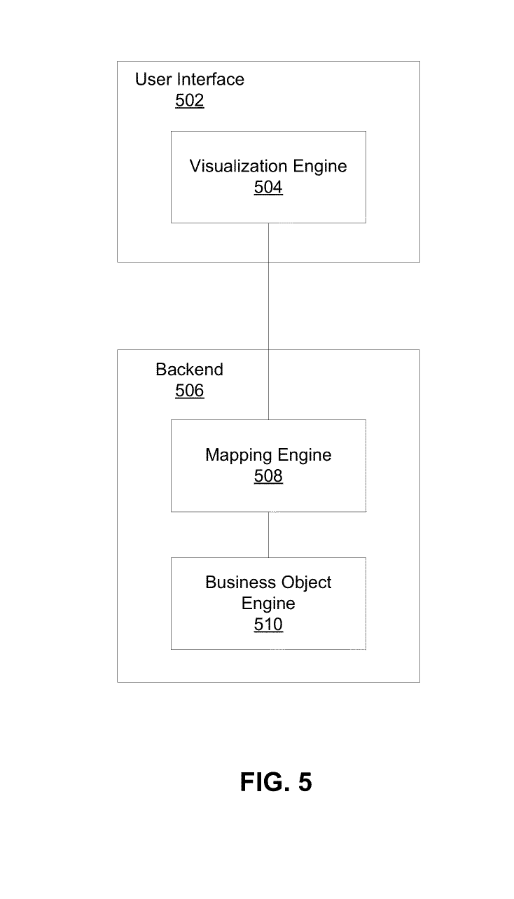

FIG. 5 shows an exemplary architecture in an embodiment of the invention. The system may include a BO engine 510. The BO engine 510 may manage administration of BOs. For example, the BO engine 510 may check the authorization level required by a user to access and/or modify one or more BOs. The mapping engine 508 may map the business attributes of BOs to visual attributes. In an embodiment, the mapping engine 508 may access and/or create the mappings (such as the mappings shown in FIG. 3) between BOs and visual representations of BOs. The visualization engine 504 may access visual BO attributes and display these visual attributes graphically to the user. The visualization engine may be a component of the user interface 502. The mapping engine 508 and the BO engine 510 may be components of a backend system 506.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
reading a mapping between a business object and a corresponding visual representation of the business object, wherein the mapping includes a relationship between the business object's attributes and the visual representation's visual attributes, and the mapping includes a relationship between the business object's attribute values and the visual representation's visual attribute values;
displaying the visual representation on a graphical user interface based on the mapping, wherein the visual representation is displayed relative to a visual context displayed on the graphical user interface; and
displaying, in response to an activation of the visual representation, additional visual attributes of the visual representation.

2. A computer-implemented method comprising:
reading a mapping between a business object and a corresponding visual representation of the business object, wherein the mapping includes a relationship between the business object's attributes and the visual representation's visual attributes, and the mapping includes a relationship between the business object's attribute values and the visual representation's visual attribute values; and
displaying the visual representation on a graphical user interface based on the mapping.

3. The computer-implemented method of claim 2, wherein the visual representation is displayed relative to a visual context displayed on the graphical user interface.

4. The computer-implemented method of claim 2, further comprising:
displaying, in response to an activation of the visual representation, a magnified view of the visual representation.

5. The computer-implemented method of claim 4, further comprising:
displaying, in response to the activation, additional visual attributes of the visual representation.

6. The computer-implemented method of claim 4, further comprising:
modifying, in response to a user action performed on the magnified view, information associated with the business object.

7. The computer-implemented method of claim 4, further comprising:
initiating, in response to a user action performed on the magnified view, an electronic communication with a person associated with the business object.

8. The computer-implemented method of claim 2, further comprising:
modifying, in response to a user action performed on the visual representation, information associated with the business object.

9. The computer-implemented method of claim 2, further comprising:
initiating, in response to a user action performed on the visual representation, an electronic communication with a person associated with the business object.

10. An apparatus comprising:
a processor to:
read a mapping between a business object and a corresponding visual representation of the business object, wherein the mapping includes a relationship between the business object's attributes and the visual representation's visual attributes, and the mapping includes a relationship between the business object's attribute values and the visual representation's visual attribute values; and
a display to:
display the visual representation on a graphical user interface based on the mapping.

11. The apparatus of claim 10, wherein the visual representation is displayed relative to a visual context displayed on the graphical user interface.

12. The apparatus of claim 10, wherein the display is further configured to:
display, in response to an activation of the visual representation, a magnified view of the visual representation.

13. The apparatus of claim 12, wherein the display is further configured to:
display, in response to the activation, additional visual attributes of the visual representation.

14. The apparatus of claim 10, wherein the processor is further configured to:
modify, in response to a user action performed on the visual representation, information associated with the business object.

15. The apparatus of claim 10, wherein the processor is further configured to:
initiate, in response to a user action performed on the visual representation, an electronic communication with a person associated with the business object.

16. A non-transitory computer-readable medium embodied with computer-executable instructions for causing a computer to execute instructions, the computer instructions comprising:
reading a mapping between a business object and a corresponding visual representation of the business object, wherein the mapping includes a relationship between the business object's attributes and the visual representation's visual attributes, and the mapping includes a relationship between the business object's attribute values and the visual representation's visual attribute values; and
displaying the visual representation on a graphical user interface based on the mapping.

17. The computer-readable medium of claim 16, wherein the visual representation is displayed relative to a visual context displayed on the graphical user interface.

18. The computer-readable medium of claim 16, wherein the computer instructions further comprise:
displaying, in response to an activation of the visual representation, a magnified view of the visual representation.

19. The computer-readable medium of claim 18, wherein the computer instructions further comprise:
displaying, in response to the activation, additional visual attributes of the visual representation.

20. The computer-readable medium of claim 16, wherein the computer instructions further comprise:
modifying, in response to a user action performed on the visual representation, information associated with the business object.
